(19) United States
(12) Patent Application Publication
(10) Pub. No.: US 2023/0161148 A1
(43) Pub. Date: May 25, 2023

(54) EASY-TO-ASSEMBLE ENDOSCOPE LENS UNIT

(71) Applicant: MEDICAL INTUBATION TECHNOLOGY CORPORATION, Taoyuan City (TW)

(72) Inventor: Yi-Ting LEE, Taoyuan City (TW)

(21) Appl. No.: 17/903,388

(22) Filed: Sep. 6, 2022

(30) Foreign Application Priority Data
Nov. 23, 2021 (TW) 110143531

(51) Int. Cl. G02B 23/24; G02B 7/02

(52) U.S. Cl. CPC G02B 23/2484; G02B 23/243; G02B 7/022; G02B 7/025

(57) ABSTRACT

An easy-to-assemble endoscope lens unit installed at a head tube of an insertion tube within an endoscope. The components of the endoscopic lens unit include a base having two extended holes, with each hole having an axis. The axes of the two extended holes being substantially parallel to one another, and each extended hole having an axis length that is greater than its radius length. The endoscopic lens unit further includes a camera lens, accommodated in one of the extended holes, with a front portion of the camera lens exposed at the base. Additionally, a projection lens is accommodated in the other extended hole, with the front portion of the projection lens also exposed at the base. The projection lens is used to project a projectile and display a predetermined pattern onto the projectile. An adhesive is applied to the base and at least one of the camera and projection lenses.

### FIELD OF THE DISCLOSURE

The present invention is related to the technology of assembling endoscope lens components in an endoscope device, and more particularly to a convenient arrangement of endoscope lens components in an endoscope lens unit.

### BACKGROUND OF THE DISCLOSURE

U.S. Pat. No. 15,252,685 discloses a three-dimensional endoscope used for a human body. The interior of the endoscope includes a plate body for fixing an image lens and projection lens. In particular, an optical axis of the projection lens is required to be set in parallel, and fixing the two lenses within the plate body can lead to a problem in that the optical axes of the two lenses are not aligned in parallel during the assembly. Also, a jig is generally required to assist with the installation. However, since the endoscope is a structure having a very small internal space regardless of whether the jig is used during the assembly, the installation for the three-dimensional endoscope can be difficult. In addition, such disclosed structure not only encounters the one problem of parallelism in optical axis, but also has another problem of determining whether the imaging or projection focal lengths of the two lenses are consistent. During assembly, the optical axis parallelism and focal lengths of the two lenses must be the same, and therefore the patented structure is very difficult to install.

The issue described above typifies the problem encountered in a conventional technology in that there is no effective or convenient way of assembling the lens and base components within the endoscope.

### SUMMARY OF THE DISCLOSURE

It is therefore an object of the present disclosure to provide a convenient structure for endoscopic lens components to allow for an easy assembly, which has the effect of simple installation as well as solving the aforementioned problems encountered in the conventional technology.

Another object of the present disclosure is to conveniently place the projection lens and the optical axis of the pickup lens in substantially parallel with one another without having to use any jig, and to easily adjust the focal length, which again has the effect of simple installation.

In order to achieve the above-mentioned objects, the present disclosure uses an easy-to-assemble endoscope lens unit installed in a head tube of an endoscope device, the endoscopic lens unit comprising a base having two extended holes running through front and rear ends of the base, each of the two extended holes having an axis, the axes of the two extended holes being substantially parallel with each other, and each of the extended holes having an axis length that is greater than a radius length of each extended hole; a camera lens accommodated in one of the extended holes, and a front portion of the camera lens is exposed to the base; a projection lens, accommodated in the other extended hole, with a front portion of the projection lens exposed to the base, the projection lens being used to project a projectile and display a predetermined pattern on the projectile; and an adhesive affixed to the base and at least one of the camera lens and the projection lens.

With the above technical features, the disclosure can solve the aforementioned problem, which has the effect of easy adjustment of focus and easy installation by the use of extended holes and adhesives that are substantially parallel to each other in the base.

### BRIEF DESCRIPTION OF THE DRAWINGS

In order to illustrate the technical features of the present disclosure in detail, exemplary embodiments are illustrated with drawings, wherein:

FIG. 1 is a perspective view illustrating an endoscopic lens unit assembled in a head tube according to a first exemplary embodiment of the present disclosure;

FIG. 2 is a perspective view of the endoscopic lens unit according to the first exemplary embodiment of the present disclosure;

FIG. 3 is an exploded view of the endoscopic lens unit according to the first exemplary embodiment of the present disclosure;

FIG. 4 is a cross-sectional view of a section along the 4-4 line of FIG. 2 according to the first exemplary embodiment of the present disclosure;

FIG. 5 is an illustrated cross-sectional view according to the first exemplary embodiment of the present disclosure;

FIG. 6 is another illustrated cross-sectional view according to the first preferred embodiment of the present disclosure;

FIG. 7 is a cross-sectional view of a section along the 7-7 line of FIG. 1 according to the first exemplary embodiment of the present disclosure;

FIG. 8 is a perspective view showing the endoscopic lens unit in operation according to the first exemplary embodiment of the present disclosure;

FIG. 9 is a perspective view of the endoscopic lens unit according to a second exemplary embodiment of the present disclosure;

FIG. 10 is an exploded view of the endoscopic lens unit according to the second exemplary embodiment of the present disclosure;

FIG. 11 is a cross-sectional view of a section along the 11-11 line of FIG. 9 according to the second exemplary embodiment of the present disclosure; and

FIG. 12 is an illustrated cross-sectional view according to the second exemplary embodiment of the present disclosure.

### DETAILED DESCRIPTION OF THE EXEMPLARY EMBODIMENTS

In order to illustrate the technical features of the present disclosure in detail, the following exemplary embodiments are cited and illustrated with accompanying drawings, among others.

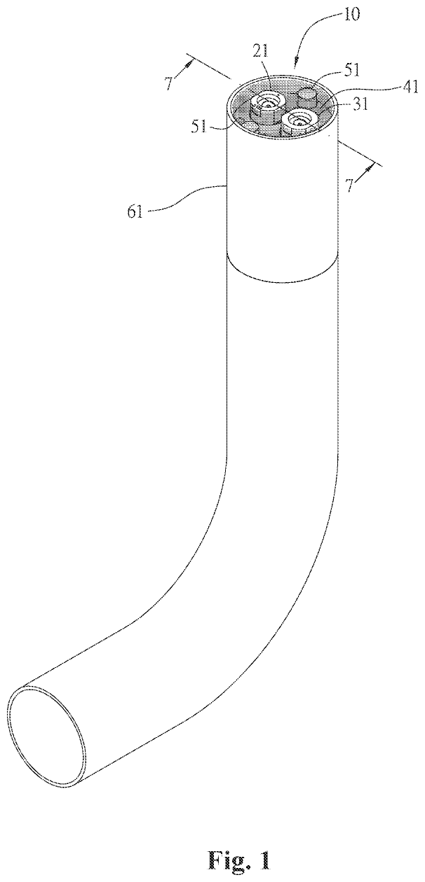

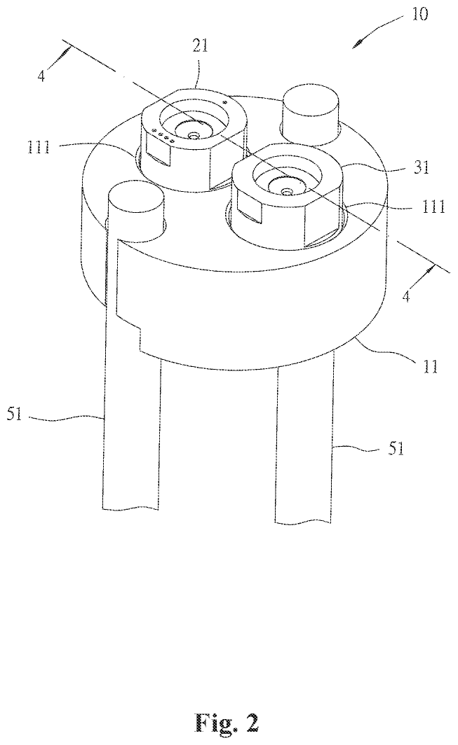

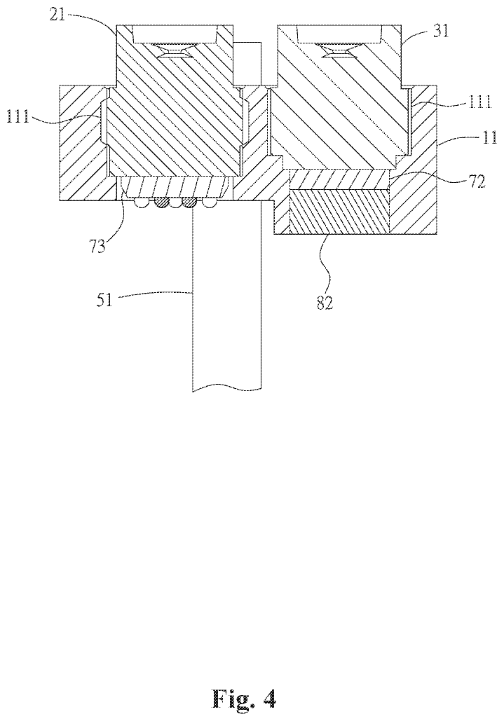

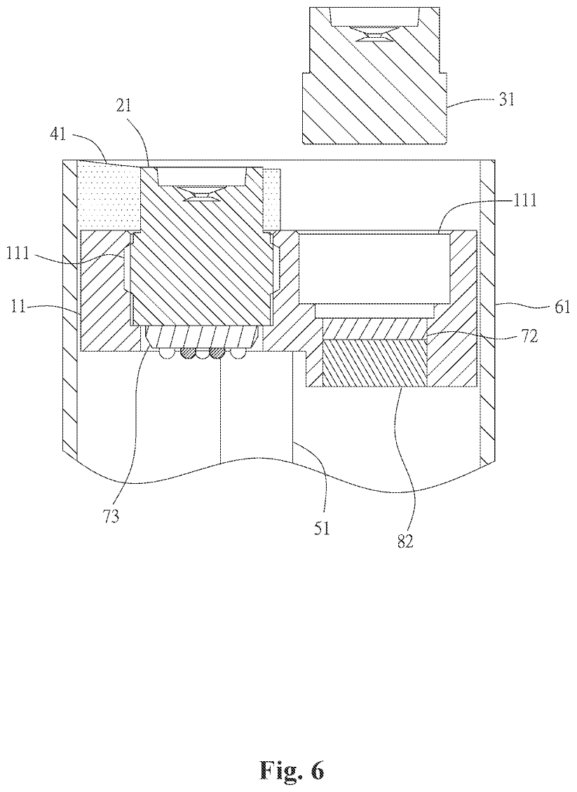

As shown in FIGS. 1 to 7, the first preferred embodiment of the present disclosure is a conveniently assembled endoscopic lens unit 10 installed in a head tube 61 of an endoscope device. The endoscopic lens unit includes a base 11, a camera lens 21, a projection lens 31, and an adhesive 41.

Other parts of the endoscope device are generally known and can be directly understood by those skilled in the art. As such, these other parts of the endoscope device connected to the head tube 61 of the insertion tube are not discussed or shown.

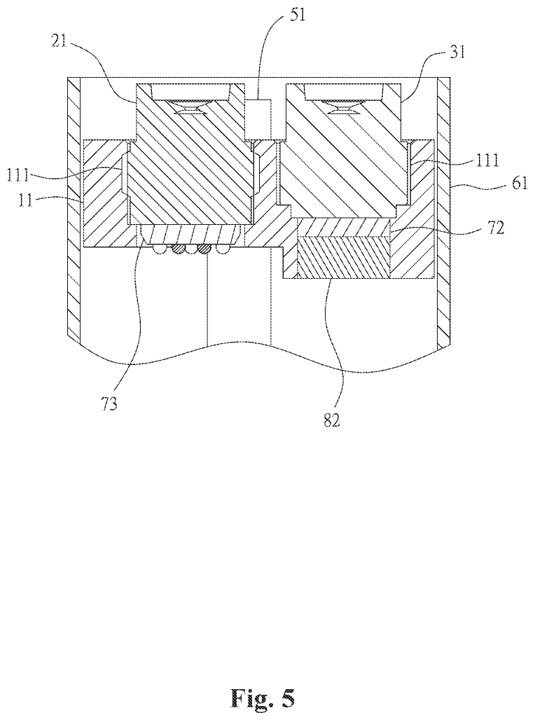

The base 11 has two extended holes 111 as shown, e.g., in FIG. 5. Each of the two extended holes 111 has an extended axis, which has an axis length that is greater than the extended hole's radius length, and the two extended holes 111 are substantially parallel to each other. The concept of each extended hole 111 having the extended axis is understood by those skilled in the art, and therefore not further discussed or illustrated.

On one hand, the camera lens 21 is accommodated in one extended hole 111 at the front end of the base 11, and the front part of the camera lens 21 is exposed at the base 11. On the other hand, the projection lens 31 is accommodated in the other extended hole 111, and used to project a projectile 71 and display a predetermined pattern 81 on the projectile 71. The adhesive 41 is applied to the base 11 and affixed to the camera lens 21 and projection lens 31. Specifically, the adhesive 41 is used to bind both the camera lens 21 and the projection lens 31 to the base 11.

In the first exemplary embodiment, the base 11 has a pair of optical fiber fixing slots 112 on opposing sides for securing a pair of optical fibers 51, respectively. The adhesive 41 in the first exemplary embodiment is a transparent curing gel, such as a transparent resin, applied to the base 11, camera lens 21 and projection lens 31 within the head tube 61. The application of the adhesive 41 at the front of the base 11 allows the adhesive 41 to serve as a protective layer and achieve a protective effect for the base 11 and the two optical fibers 51. Since the adhesive 41 is transparent, light emitted from the two optical fibers 51 can pass through to provide illumination.

The above described the structure of the first exemplary embodiment of the present disclosure. Next, the achievable effect from the structure of the first exemplary embodiment is illustrated.

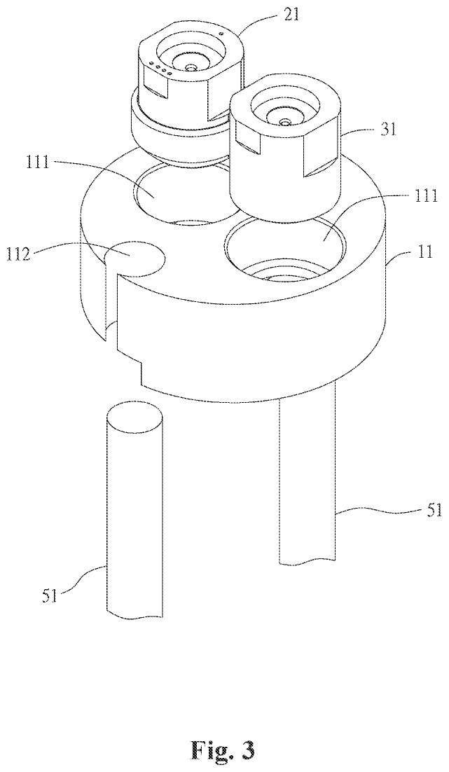

As shown in FIG. 3, both the camera lens 21 and the projection lens 31 are respectively installed in the two extended holes 111 of the base 11, and the axis length of each extended hole 111 is larger than its radius length. After the installation of the camera lens 21 and projection lens 31 into the two extended holes 111, they are constrained by the walls of the two extended holes 111 so that the camera lens 21 and the projection lens are substantially in parallel to one another. In this way, a photo axis parallel effect can be practically achieved after the installation. In addition, one of the camera lens 21 and projection lens 31 is first affixed using the adhesive 41, followed by adjusting the depth of the other one of the camera lens 21 and projection lens 31 in the extended hole 111 to attain the same focal length, and then affixing the adjusted camera lens or projection lens 31 using the adhesive 41 to complete the assembly. In this way, the optical axes of the camera lens 21 and the projection lens 31 are parallel to each other, while the focal length for each is the same. The structure of the camera lens 21 and projection lens 31 is not of a technical focus in the present disclosure, and therefore not particularly discussed or illustrated.

The present disclosure as discussed above allows for a more convenient and easy assembly as compared to the conventional technology, and at the same time resolves the issues encountered in the conventional technology. In addition, the present disclosure allows the camera lens 21 and projection lens 31 to be substantially in parallel without the use of any jig, provides an easy adjustment of the focal length, and achieves the effect of convenient installation.

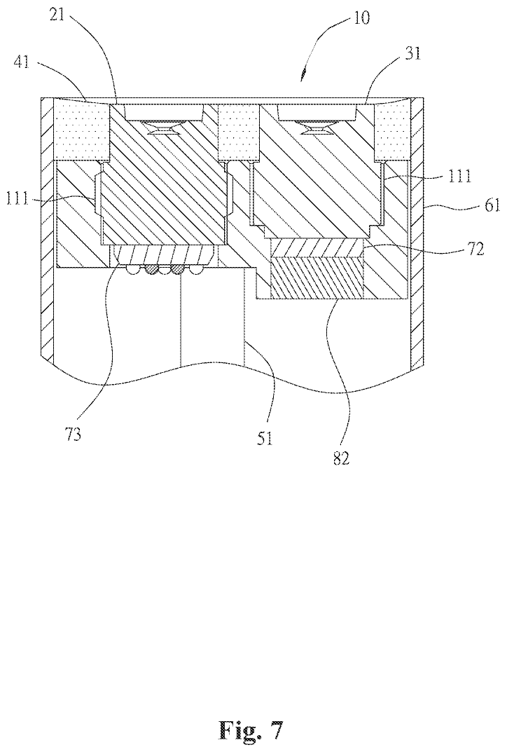

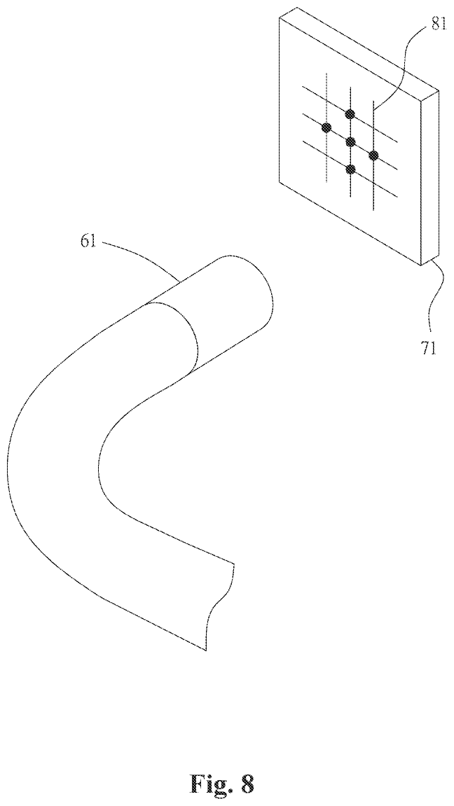

It should be added that, in the first exemplary embodiment (as shown in FIGS. 7 and 8), the bottom end of the camera lens 21 is provided with a circuit board 73, and the bottom end of the projection lens 31 is provided with a pattern board 72 and a projection light source 82. The light projected by the projection light source 82 can be a monochromatic light or white light source. In the first exemplary embodiment, a green light source is exemplarily utilized and projected by the projection light source 82 in order to pass the pattern board 72 and projection lens 31 so that a predetermined pattern 81 can be illustrated on the surface of the projectile 71.

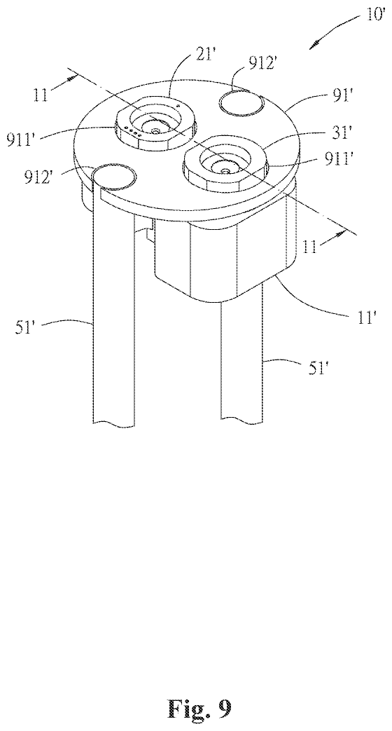

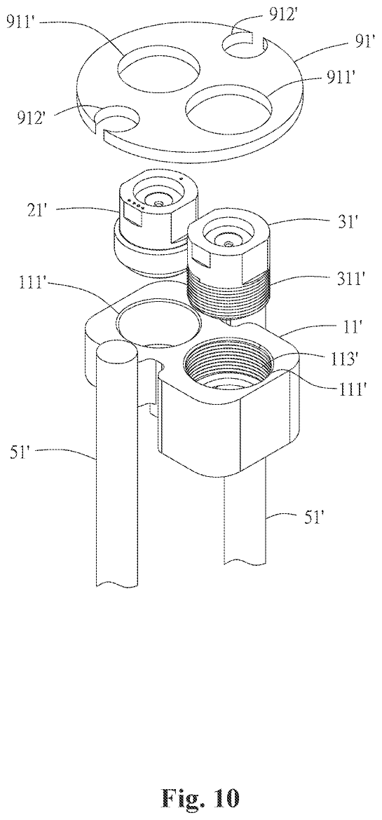

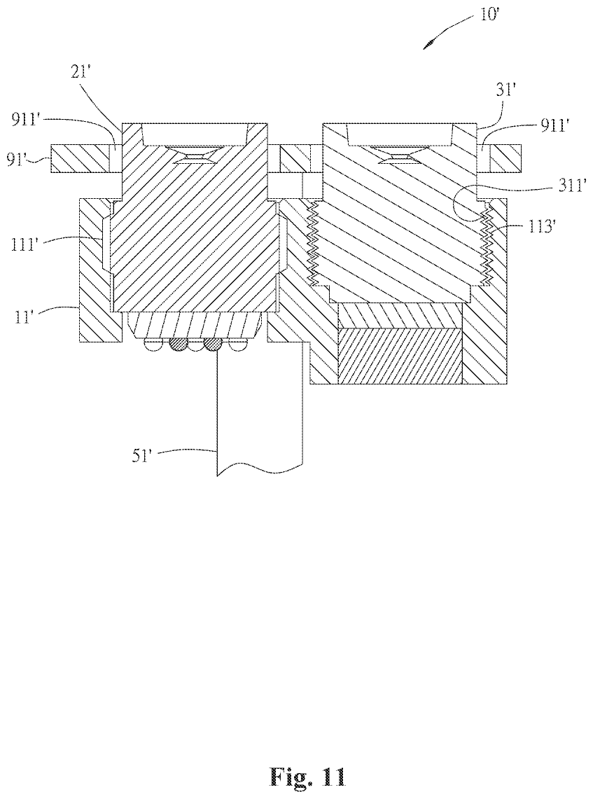

As shown in FIGS. 9 to 12, a second exemplary embodiment of the present disclosure for a conveniently assembled endoscopic lens arrangement 10′ is presented. The differences between the conveniently assembled endoscopic lens arrangement 10′ of the second exemplary embodiment and the conveniently assembled endoscopic lens arrangement 10 of the first exemplary embodiment are described below.

In the second exemplary embodiment, one of the two extended holes 111′ is provided with a female thread 113′ in the wall of the extended hole 111′ for accommodating the projection lens 31′. The camera lens 21′ and projection lens 31′ are both substantially cylindrical, with the projection lens 31′ having a portion that includes a male thread 311′ on the cylindrical surface. When the projection lens 31′ is accommodated in the extended hole 111′ with the female thread 113′, the projection lens 31′ can be fastened onto the female thread 113′, whereby the depth of the projection lens 31′ in the extended hole 111 with the female thread 113′ can be adjusted by rotating the projection lens 31′. Additionally, the focal length of the projection lens 31′ can be adjusted by rotating the projection lens 31′, thereby achieving the same focal length between the camera lens 21′ and the projection lens 31′. After the completion of the adjustment, the adhesive 41′ is applied to the base 11′. In the second exemplary embodiment, only the projection lens 31′ is shown as having the male thread 311′. However, the male thread 311′ is not limited to the projection lens 31′ since the thread 311′ can also be added to the camera lens 21′, and the female thread 113′ can be added to the other extended hole 111′ as needed.

In addition, the second exemplary embodiment further includes a positioning plate 91′, which is disposed in a head tube 61′ at the front of a base 11′. The positioning plate 91′ has two lens openings 911′ and two optical fiber fixing slots 912′. The two lens openings 911′, camera lens 21′ and projection lens 31′ are partially exposed at the front end of the positioning plate 91′. The two optical fiber fixing slots 912′ are used to accommodate two optical fibers 51′. As such, the positioning plate 91′ in the second exemplary embodiment is utilized to affix the two optical fibers 51′, and when the positioning plate 91′ is used, the affixing of the two optical fibers 51′ to the optical fiber fixing slots in the base 11′ through a manner as discussed in the first exemplary embodiment is not needed. The positioning plate 91′ can also be used to facilitate the replacement of one or more optical fibers during a maintenance operation. It is noted that the number of fiber fixing slots 912′ is not necessarily limited to a pair since such number can be adjusted depending on the number of fibers to be installed.

In addition, in the second exemplary embodiment, the adhesive 41′ is placed between the positioning plate 91′ and the base 11′, and applied to the camera lens 21′ and projection lens 31′. After the optical fiber 51′ is affixed by the positioning plate 91′, the adhesive 41′ is inserted into the gap between the positioning plate 91′ and the base 11′, and then the adhesive 41′ is cured, which allows the camera lens 21′ and projection lens 31′ to be secured to the base 11′.

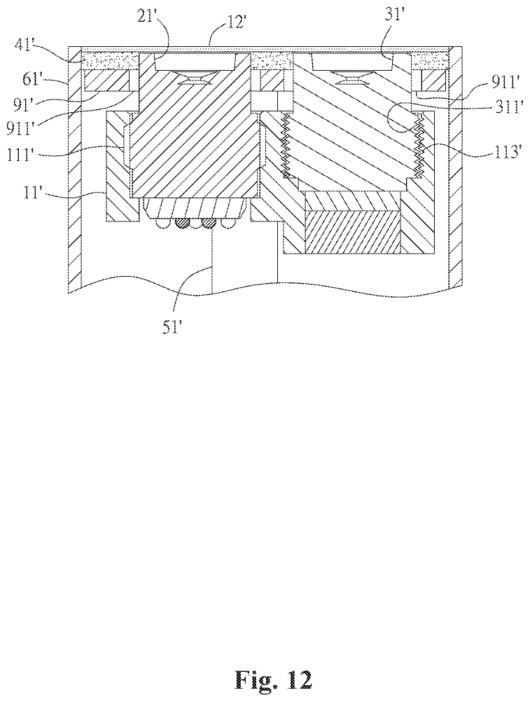

As shown in FIG. 12, instead of using the adhesive 41′ as the protection layer in a manner as described in the first exemplary embodiment, a protective layer 12′ is used as the protection layer in the second exemplary embodiment. More specifically, the protective layer 12′ is arranged in the form of a transparent sheet on the head tube 61′ at the front of a base 11′. The shape of the protective layer 12′ is not limited to the above-described transparent sheet, but can be of any shape design according to a particular use situation and serving the purpose of protecting the lenses from being damaged by environmental pollution and/or foreign objects.

The effect that the second exemplary embodiment can achieve is that, through the arrangement of the female thread 113′ and male thread 311′, an assembler can adjust the focal point by just rotating the projection lens 31′, which is extremely simple and easy to operate, and more convenient than the conventional technology. In addition, with the arrangement of the positioning plate 91′, the assembly and replacement of the two optical fibers 51′ can be better facilitated when conducting, e.g., a maintenance procedure.

The rest of the technical features and the effects achieved by the second exemplary embodiment are generally the same as those achieved by the first exemplary embodiment as disclosed above, and thus they will not be repeated.

The present disclosure has been described with reference to the exemplary embodiments, and such description is not meant to be construed in a limiting sense. It should be understood that the scope of the present disclosure is not limited to the above-mentioned embodiment, but is limited by the accompanying claims. It is, therefore, contemplated that the appended claims will cover all modifications that fall within the true scope of the present disclosure. Without departing from the object and spirit of the present disclosure, various modifications to the embodiments are possible, but they remain within the scope of the present disclosure, will be apparent to persons skilled in the art.

What is claimed is:

1. An endoscopic lens unit installed in a head tube of an endoscope device, comprising:
a base having two extended holes running through front and rear ends of the base, each of the two extended holes having an axis, and the axes of the two extended holes being substantially parallel with each other, with each of the extended holes having an axis length that is greater than a radius length of each of the extended holes;
a camera lens placed in one of the extended holes, with a front portion of the camera lens exposed to the base;
a projection lens placed in the other extended hole, with a front portion of the projection lens exposed to the base, the projection lens being used to project a projectile and display a predetermined pattern on the projectile; and
an adhesive affixed to the base and at least one of the camera lens and the projection lens.

2. The endoscope lens unit according to claim 1, wherein a wall in one of the two extended holes is provided with first threads, the camera lens and the projection lens are substantially cylindrical in shape, and one of the camera lens and the projection lens is provided with second threads in order to mate with the first threads in the wall of one of the two extended holes.

3. The endoscope lens unit according to claim 1, wherein the camera lens and the projection lens are respectively accommodated within the two extended holes at the front end of the base.

4. The endoscope lens unit according to claim 1, wherein the adhesive is used to secure the camera lens and the projection lens to the base.

5. The endoscope lens unit according to claim 1, further comprising a positioning plate disposed in the head tube at the front end of the base, the positioning plate having two lens holes and at least one optical fiber fixing slot, the camera lens and the projection lens extended pass the two lens holes and partially exposed at the front end of the positioning plate, and the at least one optical fiber fixing slot used to accommodate an optical fiber.

6. The endoscope lens unit according to claim 1, wherein the base has at least one optical fiber fixing slot for fixing an optical fiber.

7. The endoscope lens unit according to claim 1, further comprising a protective layer, which is disposed on the head tube and in front of the base.

8. The endoscope lens unit according to claim 7, wherein the adhesive is a transparent curing adhesive, which is attached to the head tube, the base, the camera lens, and the projection lens is located at the front of the base to form the protective layer.

9. The endoscope lens unit according to claim 7, wherein the protective layer is a transparent sheet.
